(19) United States
(12) Patent Application Publication
(10) Pub. No.: US 2005/0031907 A1
(43) Pub. Date: Feb. 10, 2005

(54) Magnetic recording medium and manufacturing method thereof

(76) Inventor: Hideaki Matsuyama, Tokyo (JP)

Correspondence Address: ROSSI & ASSOCIATES, P.O. BOX 826, ASHBURN, VA, 20146-0826, US

(21) Appl. No.: 10/877,795

(22) Filed: Jun. 25, 2004

(30) Foreign Application Priority Data
Jun. 25, 2003 (JP) 2003-181892

(51) Int. Cl. B05D 5/12; H05H 1/24

(52) U.S. Cl. 428/694 BF; 427/585; 427/569; 427/127; 428/694 BP

(57) ABSTRACT

A magnetic recording medium that is resistant to the spin-off phenomenon caused by high speed rotation is disclosed. The medium has a thin lubricating layer suitable for higher recording density. A manufacturing method for making the magnetic recording medium also is disclosed. The magnetic recording medium is successively laminated with at least a magnetic film, protective film, and lubricating layer on a non-magnetic substrate. The lubricating layer is an average of one molecule or less in thickness and 90% or more of the area of the lubricating layer is not chemically adsorbed to the protective film. Fluorine termination of the protective-film surface prevents the chemical adsorption of lubricant, preventing the formation of a bonded lubricating layer and leaving behind a mobile lubricating layer of approximately one molecule in thickness that is not spun off. The resistance to spin-off is due to the fact that the protective-film surface and the lubricant both consist of carbon fluoride. Therefore, such a configuration is effective in preventing the spin-off phenomenon and reducing the thickness of the lubricating layer.

### CROSS REFERENCE TO RELATED APPLICATIONS

This application claims priority from Japanese application Serial No. 2003-181892, filed on Jun. 25, 2003, entitled “Magnetic Recording Medium and Manufacturing Method Thereof,” the contents of which are incorporated by reference in their entirety.

### BACKGROUND OF THE INVENTION

A. Field of the Invention

The present invention relates to a magnetic recording medium and a manufacturing method thereof and, more particularly, to a hard-disk magnetic recording medium constituting a hard-disk device and a method of manufacturing a protective film and lubricating layer thereof.

B. Description of the Related Art

Hard-disk devices, which are major external recording devices for computers, are rapidly increasing in recording density and transfer rate and decreasing in size with the progress of multimedia. The higher recording density of the magnetic recording medium, a main component of hard-disk devices, has made it necessary to reduce the head flying height and make the protective film and lubricating layer thinner. Additionally, the medium's rotational speed has been increased as a result of the higher transfer rate. This requires that the tribological mechanical strength be maintained for the magnetic recording medium in conjunction with the enhancement of its recording density.

The magnetic recording medium, a component that magnetically records information, is successively laminated with an undercoat film, magnetic film, and protective film on a substrate, and further coated with a lubricant.

Normally, the substrate is made of an Al alloy, with the surface thereof protected by a NiP-plated layer. Further, a glass substrate is used if improved shock resistance is required.

The magnetic film for recording information is made of a Co-based ferromagnetic substance, with a Cr undercoat film applied for enhanced magnetic properties.

The magnetic film is further coated with diamond-like carbon (DLC), a hard carbon-based protective film that offers excellent lubricity and high wear resistance for protection purposes. Normally, the carbon protective film is formed by the sputter method, as with the Cr undercoat film and the magnetic film, or by the plasma CVD method using hydrocarbon gas as a raw material.

Perfluoropolyether (PFPE) is commonly used as the lubricating layer applied on top of the protective film. The lubricating layer is formed by dipping or spin coating by diluting perfluoropolyether with a solvent. The lubricating layer is approximately one to several nanometers in thickness. This thickness is approximately the same as or several fold of that of the one molecule layer of lubricant. The thickness of a one molecule layer, which is dependent on the quantity of molecules in the lubricant, is approximately twice the molecular radius of gyration (see, for example, H. Tani, IEEE Trans. On Magn., 35, 5. (1999)). This has been confirmed by atomic-force microscopy and measured to be roughly 1 nm for 2000 g/mol and roughly 1.5 nm for 4000 g/mol in the case of PFPE Z-dol.

The lubricating layer on top of the protective film is divided into two types. One of them is a layer (bonded lubricating layer) that is combined with, or chemically adsorbed to, the protective film, whereas the other is an uncombined layer (mobile lubricating layer). Experimentally, the bonded lubricating layer is not removed by rinsing thereof with a solvent such as fluorocarbon, whereas the mobile lubricating layer is removed. Having the effect of repairing the lubricating film shaved by sliding, the mobile lubricating layer has a considerable impact on the sliding property.

However, the thick mobile lubricating layer has resulted in problems which include adhering of the layer to the head, affecting the head flying height and causing sticking between the magnetic recording medium and the head, which stops rotation of the magnetic recording medium.

Moreover, because the magnetic recording medium rotates at a high speed, the mobile lubricating layer moves toward the outer perimeter (the phenomenon). This movement results in the area deprived of the mobile lubricating layer becoming easily worn and the area on the outer-perimeter side with accumulated lubricant readily adhering to the head. A the phenomenon-free bonded lubricating layer has been hitherto provided to suppress wear in the event that the mobile lubricating layer is worn away (see, for example, Japanese Unexamined Patent Application Publication No. 11-172268). For this reason, it has been impossible to make the lubricating layer thinner than a given thickness.

The present invention is directed to overcoming or at least reducing the effects of one or more of the problems set forth above.

### SUMMARY OF THE INVENTION

In light of the above, it is an object of the present invention to provide a magnetic recording medium with ability for a higher transfer rate and higher recording density, and with an increased resistance to the spin-off phenomenon caused by high speed rotation; and a manufacturing method thereof.

To achieve such an object, a magnetic recording medium according to the present invention is successively laminated with at least a magnetic film, protective film, and lubricating layer on a non-magnetic substrate, in which 90% or more of the area of the lubricating layer is not chemically adsorbed to the protective film, and in which the lubricating layer is an average of one molecule layer or less in thickness.

It is preferable if a surface of the protective film is at least fluorine-added or fluorine-terminated.

It is further preferred that the contact angle of the surface of the protective film with respect to water be 90 degrees or more.

It is also preferred that at least part of the surface of the protective film be a fluorine-added amorphous carbon-based protective film.

Moreover, a method of manufacturing a magnetic recording medium according to the present invention comprises the steps of forming a magnetic film on a non-magnetic substrate, forming a protective film on top of the magnetic film and forming a lubricating layer with an average thickness of one molecule layer or less on top of the protective film so as to ensure that 90% or more of the area of the lubricating layer is not chemically adsorbed to the protective film.

The method further preferably comprises the step of fluorine-terminating the surface of the formed protective film by decomposition of a carbon fluoride-based gas.

It is also preferred that the step of forming the protective film comprises a plasma CVD method using hydrocarbon gas to which carbon fluoride-based gas has been added as a raw material.

It is also preferred that the step of forming the protective film comprises a reactive sputter method using carbon as a target material in a sputter gas to which carbon fluoride-based gas has been added.

### BRIEF DESCRIPTION OF THE DRAWINGS

The foregoing advantages and features of the invention will become apparent upon reference to the following detailed description and the accompanying drawings, of which:

FIG. 1 shows a magnetic recording medium according to the present invention.

### DETAILED DESCRIPTION OF SPECIFIC EMBODIMENTS

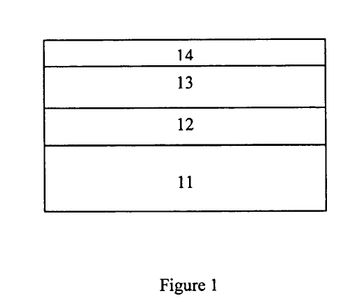

In the manufacture of the magnetic recording medium according to the present embodiments, at least a magnetic film 12, protective film 13, and lubricating film 14 are successively laminated on top of a non-magnetic substrate 11 (see FIG. 1). The steps of forming the magnetic film on the non-magnetic substrate and forming the protective film on top of the magnetic film are conventional method and a detailed thereof is therefore omitted here.

Prior to lamination of the lubricating layer, the protective-film surface is covered with fluorine (fluorination). This is followed by the formation of a mobile lubricating layer of one molecule layer or less in thickness, thus forming a lubricating layer substantially free of a bonded lubricating layer. For fluorination, any of the following methods can be adopted:
1) The protective-film surface is fluorine-terminated by decomposition of a carbon fluoride-based gas such as CF₄ (tetrafluoromethane) or C₂F₆ (hexafluoroethane) using plasma, UV irradiation, etc.
2) A fluorine-added amorphous carbon-based film is used for all or part of the surface of the protective film. For this, a fluorine-added amorphous carbon-based protective film is formed by the plasma CVD method using hydrocarbon gas to which carbon fluoride-based gas such as CF₄ or C₂F₆ has been added as a raw material.
3) A fluorine-added amorphous carbon-based film is used for all or part of the surface of the protective film. For this, the protective film is formed by the reactive sputter method using carbon as a target material in a sputter gas (e.g., Ar) to which carbon fluoride-based gas such as CF₄ or C₂F₆ has been added.

The present invention is therefore characterized in that a mobile lubricating layer of one molecule layer or less is provided without forming a bonded lubricating layer on the fluorinated surface of the protective film, unlike the prior art (Japanese Unexamined Patent Application Publication No. 5-174354, for example).

Of the bonded and mobile lubricating layers, the mobile lubricating layer contributes considerably to the sliding property. In the conventional method of using a lubricating layer that comprises both a bonded and mobile lubricating layer, the mobile lubricating layer moves to the outer-perimeter side due to the spin-off phenomenon as a result of rotation of the magnetic recording medium. This results in reduced thickness of the mobile lubricating layer. In contrast, the present invention prevents chemical adsorption of the lubricant by a method including fluorine termination of the protective-film surface, thus providing a mobile lubricating layer of one molecule or less in thickness, without forming a bonded lubricating layer. The mobile lubricating layer of one molecule layer or less thus provided is free of the spin-off phenomenon, presumably because the protective-film surface and the lubricant both contain carbon fluoride. Therefore, such a configuration is effective in preventing the spin-off phenomenon and reducing the thickness of the lubricating layer.

Here, the thickness of the one molecule layer has been determined experimentally to be the saturation value obtained when increasing the thickness of the bonded lubricating layer in the lubricating layer by heat treatment or UV irradiation, and the maximum thickness of the bonded lubricating layer in the lubricating layer applied by the vapor deposition method (see, for example, Japanese Unexamined Patent Application Publication No. 2002-324310).

In the case of Fomblin Z-dol used as lubricant in the embodiments described below, the thickness of the one molecule layer, calculated from the maximum thickness of the bonded lubricating layer applied by the vacuum vapor deposition method, was found to be approximately 1.4 nm to 1.5 nm (refer to Japanese Unexamined Patent Application Publication No. 2002-324310). For a sample obtained by thermally treating a thick lubricating layer (4 nm) applied by the dip method, the thickness of the one molecule layer, measured from the maximum thickness of the bonded lubricating layer, was found to be approximately 1.4 nm.

The fact that no bonded lubricating layer is formed indicates that the lubricating layer is substantially made of the mobile lubricating layer. Here, the term “substantially” does not mean that all of the lubricating layer constituting the lubricating layer must have fluidity, and it suffices for the percentage of lubricant having fluidity to be 90% or more. It is preferred, however, that the percentage thereof be 95% or more.

Preferred embodiments of the present invention will now be described.

### Embodiment 1

In the present embodiment, a method of fluorine-terminating the protective-film surface by the plasma CVD method will be described. A magnetic disk 65 mm in diameter was used as the substrate for the experiment. A NiP film, Cr undercoat film, CoCrTaPt magnetic film, and nitrogen-added amorphous carbon protective film were laminated in succession on top of the Al substrate for use as a sample. Fluorine termination of the protective-film surface was conducted by the ECR (electron cyclotron resonance) plasma CVD method (see Japanese Unexamined Patent Application Publication No. 2000-144429). The manufacturing conditions were as follows.
Pressure reached: 1.3×10⁴ Pa or less
Microwave: 200 W output, 2.45 GHz
Magnetic field: 1.5 kG
Reactive gas: Freon CF₄
Reaction pressure: 0.7 Pa
Gas flow rate: 20 sccm
Substrate temperature: Room temperature

A lubricating layer of 0.5 nm to 2.5 nm was applied on top of the fluorine terminated protective film. The lubricant used was Fomblin Z-dol made by Ausimont. The layer was formed by the dip method, followed by a thermal treatment (100° C.) for approximately one hour. The sample was subjected to a spin-off test in which the sample was rotated at high speed (10,000 revolutions/min) for 10 days. The thicknesses of the mobile and bonded lubricating layers were determined before and after the spin-off test. Here, the lubricating-layer thicknesses were measured by infrared spectroscopy (IR). As the lubricant contains CF bond, infrared absorption resulting from CF vibration appears near 1270 cm⁻¹, thus enabling determination of the lubricating-layer thicknesses from the amount of absorbed infrared radiation. The thickness measurements were calculated from the difference in absorption between before and after application of the lubricating layer.

Of the lubricating layers, the part that was rinsed with the fluorocarbon solvent was regarded as the mobile lubricating layer, whereas that which was not removed was regarded as the bonded lubricating layer. It is to be noted, however, that because the bonded-lubricating-layer thickness remains unchanged before and after the experiment, the post-experiment thickness was used. More specifically:
(1) Measurement was conducted by IR prior to application of the lubricating film.
(2) Measurement was similarly performed following the application of the lubricating film and prior to the spin-off test, and the total lubricating-layer thickness before the spin-off test was determined from the difference from (1).
(3) Measurement was similarly performed following the spin-off test, and the total lubricating-layer thickness after the spin-off test was determined from the difference from (2).
(4) Then, measurement was similarly performed following a 5 minute ultrasonic cleaning in the fluorocarbon solvent, and the bonded-lubricating-layer thickness was determined from the difference from (1).
(5) The bonded-lubricating-layer thickness was subtracted from the total lubricating-layer thickness before the spin-off test for use as the mobile-lubricating-layer thickness before the spin-off test.
(6) The bonded-lubricating-layer thickness was subtracted from the total lubricating-layer thickness after the spin-off test for use as the mobile-lubricating-layer thickness after the spin-off test.

The properties of the fluorine-terminated surface will be described in Embodiment 2. The spin-off-test results are shown in Table 1. The bonded lubricating layer was hardly formed due to fluorine termination of the protective film. When the mobile-lubricating-layer thickness before the spin-off test was less than 1 nm, the layer barely was spun off, and was unmoved even after the spin-off test. When the layer thickness was 1.5 nm or more, 1.2 nm of the mobile lubricating layer remained. The value, smaller than the thickness of the one molecule layer of Z-dol (approx. 1.4 nm), is close thereto, and it is clear that an approximately one molecule layer of the mobile lubricating layer remains. Therefore, when the average mobile-lubricating-layer thickness is greater than that of the one molecule layer, the film thickness is reduced to approximately that of the one molecule layer by the spin-off test. On the other hand, when the average thickness is less than that of the one molecule layer, the film thickness remains basically unchanged by the spin-off test.

Fluorine termination of the protective-film surface made it possible to almost completely eliminate the bonded lubricating layer, whereas keeping the mobile lubricating layer an average of one molecule or less in thickness enabled nearly complete elimination of layer thickness reduction in the 10-day spin-off test.

TABLE 1

| Sample | No. 1 | No. 2 | No. 3 | No. 4 |
|---|---|---|---|---|
| Mobile-lubricating-layer thickness | 0.5 | 1 | 1.5 | 2.5 |
| before spin-off test [nm] | | | | |
| Mobile-lubricating-layer thickness | 0.4 | 0.9 | 1.2 | 1.2 |
| after spin-off test [nm] | | | | |
| Bonded-lubricating-layer thickness | 0 | 0 | 0 | 0 |
| [nm] | | | | |

### Comparative Example 1

For comparison with Embodiment 1, a similar test was conducted on a magnetic disk with its protective-film surface not fluorine-terminated. A magnetic disk 65 mm in diameter was used as the substrate for the experiment. A NiP film, Cr undercoat film, CoCrTaPt magnetic film, and nitrogen-added amorphous carbon protective film were laminated in succession on top of the Al substrate for use as a sample. A lubricating layer of 0.5 nm to 2.5 nm was applied on top thereof. The lubricant used was Fomblin Z-dol made by Ausimont. The layer was formed by the dip method, with thermal treatment (100° C.) provided for approximately one hour. The sample was subjected to a spin-off test in which the sample was rotated at high speed (10,000 revolutions/min) for 10 days. The thicknesses of the mobile and bonded lubricating layers were determined before and after the spin-off test.

The spin-off-test results are shown in Table 2. A bonded lubricating layer was found to be formed on top of the protective film, with the mobile lubricating layer thinned by the spin-off test. Even when the mobile lubricating layer was reduced to a thickness of the one molecule layer or less, the majority thereof disappeared in the 10-day spin-off test.

TABLE 2

| Sample | No. 5 | No. 6 | No. 7 | No. 8 |
|---|---|---|---|---|
| Mobile-lubricating-layer thickness | 0.4 | 0.8 | 1.2 | 2.1 |
| before spin-off test [nm] | | | | |
| Mobile-lubricating-layer thickness | 0.1 | 0.15 | 0.25 | 0.3 |
| after spin-off test [nm] | | | | |
| Bonded-lubricating-layer thickness | 0.15 | 0.2 | 0.3 | 0.4 |
| [nm] | | | | |

### Embodiment 2

A description will be given of a method of making a protective film with a fluorine-added surface by forming a second protective film constituted by a fluorine-added amorphous carbon film, by the plasma CVD method, on top of a first protective film formed in advance. A fluorine-added amorphous carbon film (α-CFH) was formed instead of fluorine-terminating the protective-film surface by the ECR (electron cyclotron resonance) plasma CVD method as shown in Embodiment 1. The manufacturing conditions were the same as in embodiment 1, except that the reactive gas was a mixed gas of ethylene C₂H₆ and Freon CF₄ (CF₄ percentage: 70%, 80%).

The contact angle of the protective film with respect to water is shown in Table 3. Here, a Freon gas percentage of 100% in the reactive gas represents the condition in Embodiment 1, whereas a CF gas percentage of 0% in the reactive gas indicates the condition in Comparative Example 1. In plasma treatment using 100% Freon, the protective film was successfully formed except for slight etching of the film. As for the sample plasma-treated (fluorine-terminated) using Freon-added gas or that on which a fluorine-added amorphous carbon film was formed, fluorine was detected by photo-electron spectroscopy from the surface, indicating that the surface had been fluorinated. The findings also showed that the water contact angle was large, at 90 degrees or more. From the results, it is apparent that the surface is fluorinated.

TABLE 3

| Fluorination | Yes | | | No |
|---|---|---|---|---|
| CF gas percentage in reactive gas [%] | 100 | 80 | 70 | 0 |
| α-CFH film-forming rate [nm/s] | −0.1 | 0.01 | 0.17 | 0.8 |
| Water contact angle [deg] | 102 | 107 | 105 | 72 |

On top of the treated protective film, 1 nm to 2.5 nm of Fomblin Z-dol was applied as a lubricating layer. The samples were rotated at high speed (10,000 revolutions/min) for approximately 10 days. The measured thicknesses of the mobile and bonded lubricating layers before and after the spin-off test are shown in Table 4. As for the sample with a formed fluorine-added amorphous carbon film (Freon gas percentage: 70%, 80%), a bonded lubricating layer was hardly formed. As with Embodiment 1, the spin-off-test results show that when the average thickness of the mobile lubricating layer was greater than that of the one molecule layer, the film thickness was reduced to approximately that of the one molecule layer. On the other hand, when the average thickness was less than that of the one molecule layer, the film thickness remained roughly unchanged by the spin-off test.

TABLE 4

| Sample | No. 9 | No. 10 | No. 11 | No. 12 |
|---|---|---|---|---|
| CF gas percentage in | 80 | 80 | 70 | 70 |
| reactive gas [%] | | | | |
| Mobile-lubricating-layer | 1.0 | 2.5 | 1.0 | 2.5 |
| thickness before spin- | | | | |
| off test [nm] | | | | |
| Mobile-lubricating-layer | 0.9 | 1.3 | 0.7 | 1.2 |
| thickness after spin-off | | | | |
| test [nm] | | | | |
| Bonded-lubricating-layer | 0 | 0 | 0.05 | 0.1 |
| thickness [nm] | | | | |

Thus, fluorine termination of the protective-film surface or formation of a fluorine-added amorphous carbon film thereon almost completely eliminates the formation of a bonded lubricating layer on the surface. Further, when the average mobile-lubricating-layer thickness is greater than that of the one molecule layer, the film thickness decreases to that of the one molecule layer over the 10-day spin-off test, whereas when the average thickness is less than that of the one molecule layer, the film thickness remains basically unchanged. Therefore, keeping the mobile lubricating layer one molecule or less in thickness suppresses spin-off, forming a lubricating layer made up of a mobile lubricating layer alone—the type of lubricating layer that considerably contributes to wear resistance. Against a backdrop of the declining head flying height with an increase in the recording density, the present invention is effective for obtaining a thin lubricating layer.

As for the fluorination method, it is apparent that fluorine termination of the protective-film surface by the decomposition of a mixed carbon fluoride-based gas such as CF₄ or C₂F₆ and another gas in plasma, or the formation of a fluorine-added amorphous carbon film on the surface, is effective. Alternatively, the plasma process may be replaced, for example, by UV irradiation. It may also be possible to form the film by the reactive sputter method using a sputter gas such as Ar to which carbon fluoride-based gas such as CF₄ or C₂F₆ has been added.

It has been experimentally confirmed that it is not necessary that all of the lubricant be a mobile layer, and that the effect of the invention can be produced as long as the percentage thereof is 90% or more.

As described above, it is possible according to the present invention to implement a magnetic recording medium that is resistant to the spin-off phenomenon caused by high speed rotation and has a thin lubricating layer suitable for higher recording density.

Thus, a magnetic recording medium has been described according to the present invention. Many modifications and variations may be made to the techniques and structures described and illustrated herein without departing from the spirit and scope of the invention. Accordingly, it should be understood that the methods and devices described herein are illustrative only and are not limiting upon the scope of the invention.

1. A magnetic recording medium, comprising at least a non-magnetic substrate, a magnetic film laminated on the substrate, a protective film laminated on the magnetic film, and a lubricating layer laminated on the protective film, wherein 90% or more of the area of the lubricating layer is not chemically adsorbed to the protective film, and wherein the lubricating layer is, on average, one molecule layer or less in thickness.

2. The magnetic recording medium according to claim 1, wherein a surface of the protective film is at least fluorine-added or fluorine-terminated.

3. The magnetic recording medium according to claim 1, wherein the contact angle of a surface of the protective film with respect to water is 90 degrees or more.

4. The magnetic recording medium according to claim 1, wherein at least a part of a surface of the protective film is a fluorine-added amorphous carbon-based protective film.

5. A method of manufacturing a magnetic recording medium, comprising:
forming a magnetic film on a non-magnetic substrate;
forming a protective film on top of the magnetic film; and
forming a lubricating layer with an average thickness of one molecule layer or less on top of the protective film so as to ensure that 90% or more of the area of the lubricating layer is not chemically adsorbed to the protective film.

6. The method of manufacturing a magnetic recording medium according to claim 5, further comprising fluorine-terminating the surface of the protective film by decomposition of a carbon fluoride-based gas.

7. The method of manufacturing a magnetic recording medium according to claim 5, wherein the protective film is formed using a plasma CVD method using hydrocarbon gas to which carbon fluoride-based gas is added as a raw material.

8. The method of manufacturing a magnetic recording medium according to claim 5, wherein the protective film is formed by a reactive sputter method using carbon as a target material in a sputter gas to which carbon fluoride-based gas has been added.
